(19) United States
(12) Patent Application Publication
(10) Pub. No.: US 2012/0102738 A1
(43) Pub. Date: May 3, 2012

(54) Method of Making Progressing Cavity Pumping Systems

(76) Inventors: Hossein Akbari, (US); Julien Ramier, Bristol (GB); Tony Camuel, (US)

(21) Appl. No.: 12/915,302

(22) Filed: Oct. 29, 2010

(51) Int. Cl. B23F 15/08; F04C 2/107

(52) U.S. Cl. 29/888.023

(57) ABSTRACT

A progressing cavity rotor facilitates pumping applications in progressing cavity pumping systems by ensuring a desired shape of the rotor. A resilient layer is placed over a rotor core to create a composite progressing cavity pump system rotor. Generally, the rotor core is formed from a harder material, such as a metallic material. Additionally, the composite rotor is placed in a mold and subjected to a molding treatment designed to enhance bonding of the resilient layer and formation of a desired exterior surface shape of the resilient layer.

### BACKGROUND

Progressing cavity pumping systems, including progressing cavity motors and progressing cavity pumps, are used in a wide variety of applications. For example, progressing cavity pumping systems are employed in downhole, well applications to pump oil, water, or other types of fluids. A typical progressing cavity pumping system comprises a helical rotor which rotates within a helical stator. As the helical rotor rotates, progressing cavities are formed between the rotor and the stator in a manner which forces fluid from an inlet end to an outlet end of the system.

The efficiency with which fluid is moved through the progressing cavity pumping system depends at least in part on having a properly formed exterior of the helical rotor to form the desired progressing cavities. However, existing methods of forming the pumping system rotor present difficulties in obtaining and maintaining the desired external shape of the rotor. If the rotor is not constructed with the desired shape or if the desired shape is detrimentally changed during pumping, the overall pumping system will have a reduced pumping efficiency.

### SUMMARY

In general, a method is provided for making a progressing cavity pumping system rotor having a desired shape to facilitate pumping. The method comprises placing a resilient layer over a rotor core to create a composite progressing cavity pump system rotor. Generally, the rotor core is formed from a relatively harder material, such as a metallic material, including, but not limited to metals, composites, and powdered metals. Additionally, the composite rotor is placed in a mold which is designed to enhance the desired exterior surface shape of the resilient layer and to help secure the resilient layer to the rotor core.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a well string deployed in a wellbore with a progressing cavity pumping system, according to an embodiment of the present invention;

FIG. 2 is an illustration showing installation of a composite rotor into a corresponding stator of a progressing cavity pumping system, according to an embodiment of the present invention;

FIG. 3 is a schematic cross-sectional representation of a multi-lobe, composite rotor deployed in a stator of a progressing cavity pump;

FIG. 4 is a cross-sectional view of an example of a composite rotor having a relatively hard rotor core covered by a resilient layer, according to an embodiment of the present invention;

FIG. 5 is an illustration of the rotor core being formed in a multipiece mold, according to an embodiment of the present invention; and

FIG. 6 is a flowchart providing an example of a procedure for constructing the composite rotor, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The embodiments described herein generally relate to a method for making an improved progressing cavity pumping system, such as a progressing cavity motor or a progressing cavity pump. A progressing cavity rotor is constructed in a manner which facilitates formation of a long-lasting rotor which has an outer layer with improved material properties and a more precisely defined surface contour to enhance the pumping action of the overall progressing cavity pumping system. The method provides better control over formation of the outer material layer to facilitate the maximization of desired material properties and to enhance the pumping efficiency which results from achieving a more optimal and longer-lasting surface contour of the rotor.

According to one embodiment, a method of manufacturing a thin resilient layer rotor for progressing cavity pumping systems is provided. The method may be applied to either uniform or nonuniform resilient layers affixed over a rotor core. In this particular embodiment, the rotor is subject to a compression molding technique in which a rotor core is covered by the resilient layer and introduced to a multi-segmented mold. The mold is constructed to enable pressure buildup within the mold to promote optimal properties of the resilient layer and an improved bonding to the rotor core.

In one example, the mold is constructed to expand less than the rotor core, and this differential in thermal expansion causes the desired increase in pressure within the mold during heating. By way of example, the relatively reduced expansion of the mold can be achieved when the mold is closed over the composite rotor and secured with bolts having a low coefficient of thermal expansion relative to the material used to form the rotor core. In this manner, the interior surface of the mold is held to a reduced expansion as the rotor core expands during a heating process, thereby increasing internal pressure.

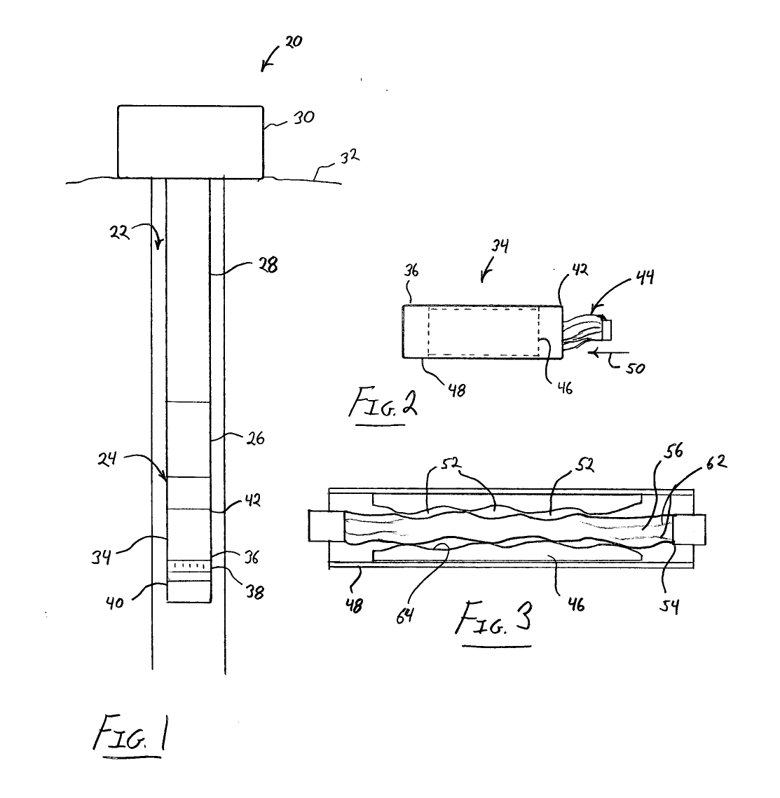

Referring generally to FIG. 1, an example is illustrated of a system and application in which a progressing cavity pumping system is employed to pump fluids. In this example, a well system 20 is illustrated as deployed in a wellbore 22 to pump fluids, such as hydrocarbon fluids, water, or other fluids. The well system 20 may have many configurations and utilize many types of components, including a progressing cavity pumping system 24. However, a variety of additional components 26, e.g. packers, connectors, valves, and many other types of components may be employed to accomplish a desired downhole application. Generally, the progressing cavity pumping system 24 and other components 26 are deployed downhole into the wellbore 22 via a conveyance 28, such as coiled tubing, production tubing, wireline, cable, or other suitable types of conveyance.

In FIG. 1, the progressing cavity pumping system 24 is deployed downhole below surface equipment 30, e.g. a wellhead, which is positioned at a desired surface location 32. The progressing cavity pumping system 24 may be constructed in a variety of sizes and configurations. For example, the pumping system 24 may comprise progressing cavity motors and progressing cavity pumps. In the embodiment illustrated, the pumping system 24 comprises a pump 34 which is designed to draw fluid in at a first longitudinal end 36 via a pump intake 38. The pump 34 is powered by a motor 40 or other suitable power source to force progression of the fluid through the pump 34 before being discharged at an opposite longitudinal end 42.

Referring generally to FIG. 2, an embodiment of pump 34 is illustrated as being constructed by installation of a composite rotor 44. In this embodiment, composite rotor 44 is inserted into a corresponding stator 46 positioned within a surrounding housing 48 of pump 34. The composite rotor 44 is moved into stator 46, as indicated by arrow 50, until the rotor 44 is fully inserted within stator 46, as illustrated in FIG. 3. Within stator 46, the composite rotor 44 may be rotated via, for example, motor 40 to force the progression of fluid through a plurality of progressing cavities 52 from inlet pump end 36 through discharge pump end 42.

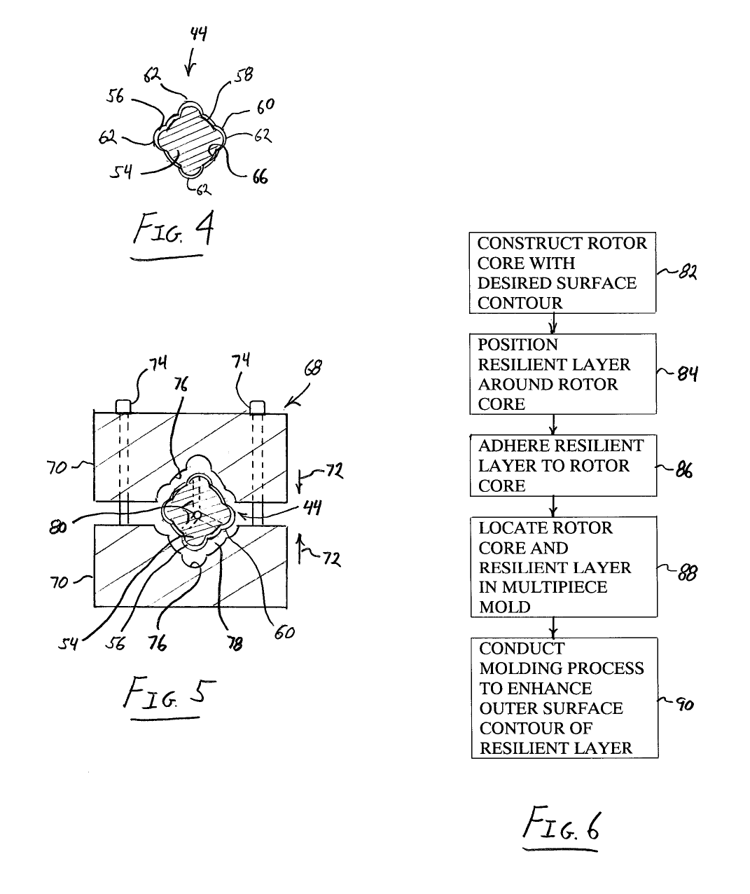

The composite, progressing cavity pump rotor 44 comprises a rotor core 54 to which a surrounding, resilient layer 56 is affixed. The composite rotor 44 may have a variety of forms and configurations depending on the design and the capacity of the overall progressing cavity pumping system 24 and on the environment in which the pumping system 24 is operated. For example, both the rotor core 54 and the resilient layer 56 may have a variety of surface contours 58, 60, respectively, as further illustrated in FIG. 4. The improved molding technique, described in greater detail below, enables affixation of the resilient layer 56 to the contoured surface 58 of rotor core 54 in a manner which provides a precise and desired profile of the composite rotor 44 along the external, contoured surface 60 of resilient layer 56.

In the specific example illustrated, composite rotor 44 is formed as a helical rotor. Depending on the desired pumping capacity and pumping characteristics of pumping system 24, the helical, composite rotor 44 may be formed as a multi-lobe rotor having a plurality of rotor lobes 62 (see FIGS. 3 and 4). The rotor lobes 62 are each oriented in a generally helical pattern along the composite rotor 44 and cooperate with an appropriately designed corresponding interior surface 64 of stator 46, as best illustrated in FIG. 3. In one embodiment, the helical, composite rotor 44 is a four lobe design in which four rotor lobes 62 are arranged in a helical pattern and with a desired pitch through the substantial length of the rotor 44. However, the composite rotor 44 may be designed with a greater or lesser number of rotor lobes 62. The molding process ensures secure adhesion to the rotor core 54 while also ensuring formation of the precise, desired external contour or profile 60 of resilient layer 56.

To enhance a long-lasting affixation of resilient layer 56 to rotor core 54, an adhesive 66, e.g. an adhesive layer, may be applied between rotor core 54 and resilient layer 56. For example, an adhesive layer may be applied to the external, contoured surface 58 of rotor core 54. Additionally, or in the alternative, adhesive may be applied to an interior of the resilient layer 56 prior to placing the resilient layer 56 around rotor core 54. In some embodiments, the resilient layer 56 is positioned over rotor core 54 in tubular form or by wrapping a sheet of the resilient material over the rotor core. For example, the resilient layer 56 may be formed as a rubber sleeve and positioned over the rotor core 54 prior to the molding process. The adhesive 66 can be applied prior to locating the resilient layer material over the rotor core and prior to the molding process. Furthermore, the adhesive 66 may be cured during the molding process or the adhesive may be allowed to set independently of the molding process, depending on the specific type of adhesive desired and on the types of materials used to form the rotor core 54 and the surrounding resilient layer 56.

The materials of rotor core 54 and resilient layer 56 may be selected according to a variety of parameters related to the progressing cavity pumping system 24 and/or the environment in which the pumping system is employed. For example, many applications are amenable to employing a metallic rotor core 54, although other materials, e.g. ceramic materials, may be suitable in some applications. By way of example, the metallic rotor core 54 may be constructed from materials such as steel, stainless steel, aluminum, titanium, and other suitable metals. As used herein, metallic rotor core includes rotor cores (e.g., 54) formed from composite materials and powder metal cores. According to one embodiment, rotor core 54 is formed as a composite rotor core by combining materials, such as metallic and non-metallic materials; dissimilar metallic materials; or dissimilar non-metallic materials.

Similarly, the resilient layer 56 may be formed of several types of suitable materials, including polymer materials, rubber materials, and other resilient materials. The materials are selected based, at least in part, on their suitability for long-term use in the working conditions of the composite rotor 44. For example, if the progressing cavity pumping system 24 is employed in a downhole, wellbore environment, the resilient material 56 must be able to function properly in the high temperature, high-pressure, and deleterious chemical environment often found downhole. Resilient layers 56 formed of rubber may be selected from the families of rubbers acceptable for downhole use, including fluoroelastomers (Viton or similar rubbers), per-fluoroelastomers, carboxylated hydrogenated nitrile-butadiene rubber (XHNBR), hydrogenated nitrile-butadiene rubber (HNBR), nitrile-butadiene rubber (NBR), and various nitrile rubbers. The rubber material forming resilient layer 56 also may be fully or only partially cured depending on the application. In some environments and applications, high temperature resistant polymers also may be employed. Examples of such polymers include polymers which become rubbery above their glass transition temperature (Tg), such as polyetheretherketone (PEEK). These latter types of materials are non-resilient at room temperatures, but they become resilient when heated above their known or predetermined glass transition temperatures (Tg). Depending on the materials selected for the rotor core 54 and the resilient layer 56, adhesive 66 may be applied between the rotor core 54 and the resilient layer 56 to improve the bonding therebetween.

In an alternate embodiment, the external surface of the rotor core 54 and/or the internal surface of resilient layer 56 may be prepared in a manner also designed to enhance bonding between the rotor core 54 and resilient layer 56. For example, a surface treatment such as a plasma treatment can be applied to one or more of the bonding surfaces. The surface treatment may be used alone or in combination with adhesive 66 to improve the bonding between materials.

Regardless of whether adhesive 66 is applied between the rotor core 54 and resilient layer 56, the resilient layer 56 is securely bonded to the rotor core 54 by a molding process. The rotor core 54, e.g. metallic rotor core, and the surrounding layer of resilient material 56 are placed within a mold 68, as illustrated in FIG. 5. The mold 68 may be formed as a mold shell having a plurality of pieces 70 which may be forced together over the composite rotor 44, as indicated by arrows 72. In the example illustrated in FIG. 5, mold 68 is illustrated as being a multipiece mold with two separate pieces 70 securely drawn together to enclose the composite rotor 44 during the mold process. However, the multipiece mold 68 may be formed with additional pieces selectively engaged via a variety of mechanisms. One example of a mechanism for selectively closing and opening mold 68 comprises a plurality of fasteners 74, e.g. bolts, which extend through one mold piece for threaded engagement with the adjacent mold piece.

The mold 68 may be constructed with different numbers of molded pieces 70 having different configurations, but regardless of the number and configuration, the mold pieces cooperate to provide an interior mold surface 76 which has an appropriate profile to form the desired surface contour/profile 60 of resilient layer 56. By way of example, mold surface 76 may be formed in a helical shape with an opposite profile of the finished composite rotor 44 to ensure the mold shell provides resilient layer 56 with the precise and desired final profile to enable efficient pumping when operated in the corresponding stator 46.

Mold 68 is designed to facilitate affixation of the resilient layer 56 to the rotor core 54 and to provide a specific, long-lasting surface contour 60 for the resilient layer 56. In other words, the multipiece mold 68 is designed to enhance an exterior surface shape of the resilient layer 56 by enabling application of one or more desired mold processes to the composite rotor 44. According to one embodiment, the materials and configuration of mold 68 are selected such that during application of heat to mold 68 and rotor core 54, the rotor core expands greater than the corresponding mold pieces 70 to cause pressure buildup inside the mold as the temperature rises. The mold 68 (or portions of the mold 68) may be constructed from materials having a lower thermal coefficient of expansion than that of the material used to construct rotor core 54. Depending on the materials used to construct composite rotor 44, components of mold 68 may be formed from a variety of materials, including steel, stainless steel, aluminum, titanium and other suitable materials.

In the specific example illustrated, bolts 74 may be constructed from material having a lower coefficient of thermal expansion compared to the rotor core 54. Consequently, heating of the rotor core 54 and/or mold pieces 70 causes greater expansion of the rotor core and thus increased pressure within a mold cavity 78 defined by mold surface 76. The increased pressure causes improved formation of the surface contour 60 and better adhesion between resilient layer 56 and rotor core 54. In some applications, vacuum passages 80 also may be formed in rotor core 54 for cooperation with the contoured rotor core surface 58. The vacuum passages 80 allow application of a vacuum to an interior of resilient layer 56 during the molding process to further enhance adherence of the resilient layer 56 to the rotor core 54 while creating a precisely defined external surface contour 60.

In other embodiments, alternate or additional techniques may be employed to build up pressure within mold 68. The increased pressure enhances bonding of the resilient layer 56 to rotor core 54 and also improves the external profile 60 of the resilient layer 56. Examples of alternate techniques to increase the mold pressure acting on the resilient layer 56 of composite rotor 44 include application of mechanical or hydraulic clamping pressure against the mold pieces 70 to increase the internal pressure between the internal surface 76 of the mold and the composite rotor 44 located therein. The mechanical or hydraulic clamping pressure may be applied alone or in combination with heating, as described above. Additionally, shrinkable wraps including shrinkable nylon wrapping can be placed around the mold pieces 70 to increase the pressure. When the shrinkable wrapping passes a certain temperature, the material begins to shrink and applies a clamping force to the mold to increase internal pressure. Independent of the method used for building internal pressure, the composite rotor 44 may be molded as a single, long unit in a single molding run. Alternatively, the composite rotor 44 may be molded in sections in which shorter sections of the composite rotor 44 are separately subjected to the molding process. For example, short adjacent sections of the composite rotor may be molded sequentially. Other methods of mold filling also may be employed, including transfer molding and injection molding. For example, the resilient layer 56 can be injection molded around the rotor core 54.

Referring generally to FIG. 6, a flowchart is provided to illustrate one example of a methodology for forming the composite rotor 44. One of the principles of the manufacturing methodology or technique is to use mold 68 in a manner designed to create a precise and accurate shape or contour for the outer surface 60 of the overall composite rotor 44. The method ensures contoured surface 60 has the desired profile, cross-section, and pitch for the one or more lobes 62 wrapped in a helix or other desired pattern. It should be noted that mold pieces 70 and the internal mold surface 76 may be formed by machining or by another suitable process to achieve the precise pattern desired for forming the contoured surface 60 of composite rotor 44.

As illustrated in FIG. 6, rotor core 54 is initially constructed, e.g. machined, with the desired surface contour 58, as represented by block 82. Subsequently, resilient layer 56 is positioned around the rotor core 54, as represented by block 84. The resilient layer 56 may be in the form of a tube or a sheet of an appropriate rubber, temperature resistant polymer, elastomer, or other suitable resilient material when it is positioned around the rotor core 54. In many applications, the rotor core 54 is formed from a metallic material, and both the metallic material and the resilient material of layer 56 are selected for use in hot, high-pressure, harsh well environments.

If adhesive 66 is employed, the adhesive 66 may be applied between the tube or sheet of resilient material 56 and the rotor core 54 to securely adhere the resilient layer 56 to the rotor core 54, as represented by block 86. By way of example, the adhesive 66 may be applied onto a metal material of the rotor core 54 and/or to an internal surface of the resilient material used to form resilient layer 56. In many applications, the adhesive 66 is applied before the resilient material is positioned around the rotor core. Additionally, several techniques may be employed for applying the adhesive 66, including spraying, brushing, and other suitable application techniques.

The rotor core 54 and the resilient layer 56 are then located in the multipiece mold 68, as represented by block 88. By way of example, the combined rotor core 54 and resilient layer 56 may be positioned generally in the middle of the open mold 68 and can be centralized by an appropriate fixture, such as end caps fitted at longitudinal ends of the mold 68. The internal mold surface 76 may be prepared with an appropriate release agent to facilitate release of the composite rotor 44 after completion of the molding process. Subsequently, the mold 68 is closed over the combined rotor core 54 and resilient layer 56. Depending on the design of mold 68 and mold pieces 70, the technique for closure of the mold may vary. However, in the example illustrated in FIG. 5, bolts or other fasteners 74 simply are turned to tighten the upper mold piece 70 against the lower mold piece 70 to fully enclose the rotor core 54 and resilient layer 56. It should be noted that FIG. 5 provides a cross-sectional view to facilitate an understanding of the positioning of the composite rotor 44 within mold 68. However, one of ordinary skill in the art would understand that mold 68 can be designed with longitudinal ends to fully enclose the composite rotor 44 during the molding process.

Once mold 68 is closed, a desired molding process is conducted to create desired properties of the composite rotor 44, as represented by block 90. For example, the molding process may be designed to ensure affixation of the resilient layer 56 to rotor core 54, to obtain desired properties in the resilient layer, and/or to enhance the outer surface contour of resilient layer 56. Additionally, the shell design of mold 68 and the material selection for both mold 68 and rotor core 54 may further facilitate the molding process.

As described above, the materials of mold 68 and rotor core 54 may be strategically selected to cause a buildup in pressure during heating. For example, heat may be applied to the mold 68 and/or the internal composite rotor 44 during curing of resilient layer 56. The heat causes the rotor core 54 and the mold 68 to expand. However, if the materials are selected properly the rotor core 54 expands more than the surrounding mold components 70 to create the increased pressure. One method for limiting the expansion of mold 68 is to use bolts 74 with low thermal expansion in a multipiece mold design, such as that illustrated in FIG. 5. Other techniques, including hydraulic clamping, also may be employed to increase the internal pressure, as discussed above. The resultant buildup in pressure is used to create better material properties in resilient layer 56, to promote an improved and long-lasting surface contour 60, and/or to encourage bonding between the resilient layer 56 and rotor core 54.

The profile of composite rotor 44 is controlled by making the appropriate design/material choices for both the rotor core 54 and the mold shell 68, e.g. selecting materials with dissimilar coefficients of thermal expansion. However, other components and materials also may be selected to affect the resultant, composite rotor 44. For example, the resilient layer 56 may be inserted into mold 68 with rotor core 54 as a partially cured rubber. When the mold is closed and temperature is applied, the elastomer/rubber is fully cured. The heating and curing also is beneficial in assisting bonding of a variety of resilient materials to the rotor core 54 which may be formed from a metallic material. Thus, the molding process may be used to improve the component stability of the composite rotor 44 and extend the life of the progressing cavity pumping system 24. The curing and/or application of heat and pressure further ensures that the outer rotor profile accurately matches the designed profile selected for use with a given stator 46. Following the heating/curing process, mold 68 is opened and the composite rotor 44 is removed for use in a corresponding stator 46.

The progressing cavity pumping system 24 may be designed for use in many types of applications in downhole locations or other locations. Additionally, the materials employed are selected according to the application and environmental factors to which the pumping system is subjected. The contour of the rotor core and the consequent contour of the resilient layer also may be selected according to the parameters of a given application and/or environment. For example, the resilient layer may be of a constant thickness or variable thickness. Additionally, the number, pitch, and configuration of the rotor lobes may be selected according to the specific parameters of a given application. Similarly, the number, design, and materials of the mold may vary according to the size, configuration, materials, and desired end characteristics of the composite rotor.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method of manufacturing a rotor for a progressing cavity pump system, comprising:
providing a metallic rotor core with a helical shape;
locating the metallic rotor core within a mold having an interior surface with a desired helical pattern;
placing a resilient layer around the metallic rotor core;
applying an adhesive between the metallic rotor core and the resilient layer; and
heating the metallic rotor core and the resilient layer while in the mold in a manner such that the metallic rotor core expands more than the mold to increase pressure buildup in the mold.

2. The method as recited in claim 1, further comprising removing the metallic rotor core and the resilient layer from the mold once the resilient layer is securely affixed to the metallic rotor core.

3. The method as recited in claim 2, wherein placing comprises positioning a rubber sleeve over the metallic rotor core.

4. The method as recited in claim 1, wherein providing comprises providing the metallic rotor core with at least one lobe arranged in the helical shape.

5. The method as recited in claim 1, wherein placing comprises wrapping the resilient layer around the metallic rotor core.

6. The method as recited in claim 1, wherein placing comprises placing a rubber tubular layer around the metallic rotor core.

7. The method as recited in claim 1, wherein placing comprises utilizing a material for the resilient layer which transitions from a hard material to a resilient material when heated above a predetermined transition temperature (Tg).

8. The method as recited in claim 1, wherein locating comprises locating the metallic rotor core and the resilient layer within a multipiece mold and closing the multipiece mold with bolts having a lower coefficient of thermal expansion than the metallic rotor core.

9. The method as recited in claim 1, further comprising forming the metallic rotor core with vacuum holes; and applying a vacuum at the vacuum holes to enhance shaping of the resilient layer over the metallic rotor core.

10. A method, comprising:
placing a resilient layer over a metallic rotor core having a helical shape;
forming a mold with an interior surface having a desired helical shape corresponding to the helical shape of the metallic rotor core; and
holding the metallic rotor core and the resilient layer within the mold under increased pressure to enhance the desired profile of a resulting progressing cavity pumping system rotor.

11. The method as recited in claim 10, wherein placing comprises placing a polymer layer over the metallic rotor core.

12. The method as recited in claim 10, wherein placing comprises utilizing a material for the resilient layer which transitions from a hard material to a resilient material when heated above a predetermined transition temperature (Tg) above room temperature.

13. The method as recited in claim 10, wherein holding comprises heating the metallic rotor core to cause greater expansion of the metallic rotor core than the mold, resulting in increased internal pressure.

14. The method as recited in claim 10, wherein holding comprises increasing the pressure within the mold by applying at least one of mechanical clamping, hydraulic clamping, and wrapping the mold with a shrinkable material.

15. The method as recited in claim 10, further comprising applying an adhesive between the resilient layer and the metallic rotor core.

16. The method as recited in claim 10, further comprising applying a surface treatment to at least one of the metallic rotor core and the resilient layer to enhance bonding between the metallic rotor core and the resilient layer.

17. The method as recited in claim 10, wherein forming comprises bolting together a plurality of mold pieces with bolts having a lower thermal expansion coefficient than the metallic rotor core.

18. The method as recited in claim 12, wherein placing comprises positioning a rubber sleeve over the metallic rotor core.

19. The method as recited in claim 12, further comprising molding the resulting progressing cavity pumping system rotor in a single run.

20. The method as recited in claim 12, further comprising molding the resulting progressing cavity pumping system rotor in a plurality of separate sections.

21. The method as recited in claim 12, further comprising molding at least part of the resulting progressing cavity pumping system rotor via injection molding or transfer molding.

22. A method, comprising:
placing a resilient layer over a rotor core to create a composite progressing cavity pump system rotor;
positioning the composite progressing cavity pump system rotor in a multipiece mold; and
using the multipiece mold to enhance an exterior surface shape of the resilient layer.

23. The method as recited in claim 22, wherein using comprises heating the rotor core in a manner which creates greater expansion of the rotor core than the multipiece mold to generate increased pressure acting on the resilient layer within the mold.

24. The method as recited in claim 22, wherein placing comprises placing the resilient layer over a composite rotor core.
